(19) United States
(12) Patent Application Publication
(10) Pub. No.: US 2008/0110739 A1
(43) Pub. Date: May 15, 2008

(54) Touch-sensor device having electronic component situated at least partially within sensor element perimeter

(75) Inventors: Tao Peng, Shanghai (CN); Guang Hai Li, Shanghai (CN)

Correspondence Address: BLAKELY SOKOLOFF TAYLOR & ZAFMAN, 1279 OAKMEAD PARKWAY, SUNNYVALE, CA, 94085-4040, US

(73) Assignee: Cypress Semiconductor Corporation

(21) Appl. No.: 11/599,234

(22) Filed: Nov. 13, 2006

(51) Int. Cl. H01H 13/70; H01H 11/00

(52) U.S. Cl. 200/5 R; 29/622

(57) ABSTRACT

A touch-sensor device including a substrate, a plurality of sensor elements, an active electronic component, and a plurality of traces is described. The plurality of sensor elements are non-linearly disposed upon the substrate and can define a perimeter. The active electronic component can be disposed upon the substrate and situated at least partially within the perimeter. The plurality of traces can be disposed upon the substrate to couple with the plurality of sensor elements and the active electronic component. The substrate may have an area approximately equal to an area of the perimeter.

### TECHNICAL FIELD

Embodiments of the present invention relate to capacitive sensor devices, and more specifically to a touch-sensor device having an electronic component situated at least partially within a perimeter defined by sensor elements.

### BACKGROUND

Electronic devices that require user interaction contain a user interface. Through user interfaces, users are able to initiate functions, issues commands, respond to device inquiries, and so on. The type of user interface used is largely dependent on the type of electronic device, on the device's purpose, and on its operating environment. For example, desktop computers use a mouse and keyboard as a user interface. In contrast, cellular phones generally use a series of small buttons as a user interface.

For portable electronic devices, it is generally desirable to make the devices as small as possible. In some portable electronic applications, such as in certain cellular phones and music players, standard buttons and switches consume too much space. In order to reduce the size of portable electronic devices without reducing functionality, manufacturers are adopting the use of capacitive sensors.

Though capacitive sensors consume less space than traditional buttons and sliders, some amount of physical space is still occupied. Even where the capacitive elements themselves occupy little physical space, the substrate on which they are disposed can still occupy an undesirable amount of space. Some attempts have been made to reduce the physical space occupied by the substrate by placing the active electronic component of capacitive sensors close among the sensing elements.

FIG. 1 illustrates a top view of a conventional capacitive sensor arrangement 100. The capacitive sensor arrangement 100 shows three sensor elements 107 vertically aligned and electrically connected with an active electronic component 105 with three traces 110. In the configuration shown in FIG. 1, a vertical center 115 is shown for the three sensor elements 107. The active electronic component 105 has been placed along the vertical center 115 such that it is centered vertically among the three sensor elements 107. The three sensor elements 107 define a sensing area 112 that is smaller than a substrate area 103. The substrate area 103 determines how much space is required to use the capacitive sensor arrangement 100 in a device.

In the configuration illustrated in FIG. 1, the substrate area is considerably greater than the sensing area. A reduction of the substrate size could allow for smaller devices without impacting performance. Moreover, the length 118 of at least some of the traces 110 can be over 6 centimeters. At a length of 6 centimeters, traces absorb electromagnetic interference of radio frequency (RF) signals above about 1.25 GHz. Such absorption increases signal noise and reduces sensitivity.

### BRIEF DESCRIPTION OF THE DRAWINGS

The present invention is illustrated by way of example, and not by way of limitation, in the figures of the accompanying drawings and in which:

FIG. 1 illustrates a conventional capacitive sensor arrangement;

FIG. 2A illustrates a top view of a touch-sensor device, in accordance with one embodiment of the present invention;

FIG. 2B illustrates a bottom view of a touch-sensor device, in accordance with one embodiment of the present invention;

FIG. 2C illustrates a side view of a touch-sensor device, in accordance with one embodiment of the present invention;

FIG. 3A illustrates a top view of a touch-sensor device, in accordance with one embodiment of the present invention;

FIG. 3B illustrates a bottom view of a touch-sensor device, in accordance with one embodiment of the present invention;

FIG. 3C illustrates a side view of a touch-sensor device, in accordance with one embodiment of the present invention;

FIG. 4A illustrates a top view of a touch-sensor device, in accordance with one embodiment of the present invention;

FIG. 4B illustrates a bottom view of a touch-sensor device, in accordance with one embodiment of the present invention;

FIG. 4C illustrates a side view of a touch-sensor device, in accordance with one embodiment of the present invention;

FIG. 5A illustrates a top view of a touch-sensor device, in accordance with one embodiment of the present invention;

FIG. 5B illustrates a side view of a touch-sensor device, in accordance with one embodiment of the present invention; and

FIG. 6 illustrates a flow diagram of a method for manufacturing a touch-sensor device, in accordance with one embodiment of the present invention.

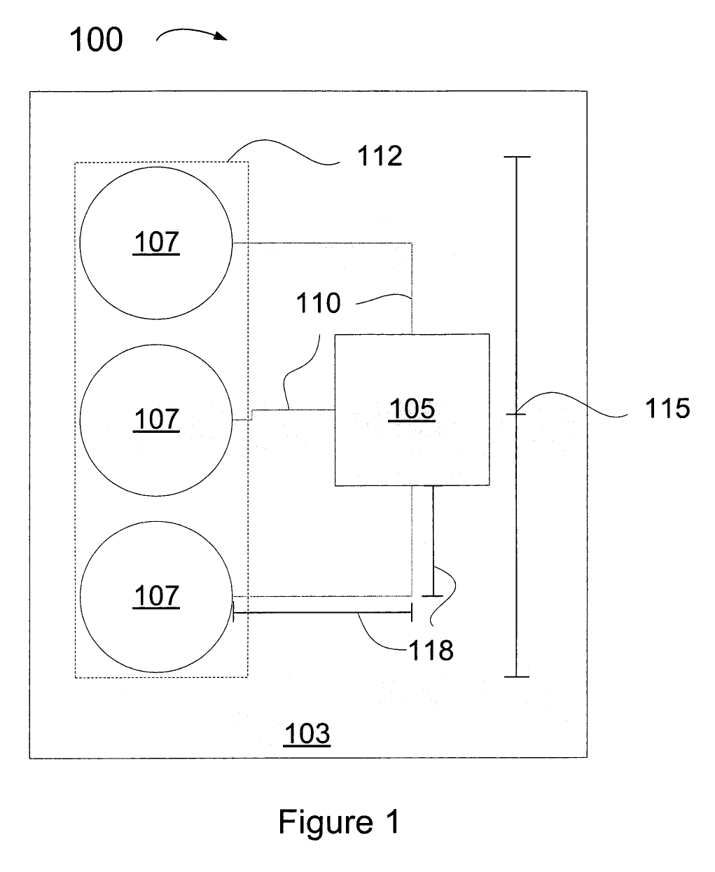

### DETAILED DESCRIPTION

In the following description, for purposes of explanation, numerous specific details are set forth in order to provide a thorough understanding of the present invention. It will be evident, however, to one skilled in the art that the present invention may be practiced without these specific details. In some instances, well-known circuits, structures, and techniques are not shown in detail, but rather in a block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment.

It should be noted that the term “layer” as used herein refers to a side of a non-conductive substrate, as is conventional in the field of multi-layer touch-sensor devices. For example, on a two-layer touch-sensor device, the top layer can refer to a first side of the substrate, and the bottom layer can refer to a second side of the substrate. The methods and apparatus described herein may be used with electronic devices such as laptop computers, mobile handsets, and PDAs. Alternatively, the methods and apparatus herein may be used with other types of devices.

A touch-sensor device including a substrate, a plurality of sensor elements, an active electronic component, and a plurality of traces is described. In one embodiment, the plurality of sensor elements are non-linearly disposed upon the substrate and may define a perimeter. In one embodiment, the perimeter defined by the plurality of sensor elements is a circle. The active electronic component may be disposed upon the substrate and situated at least partially within the perimeter. In one embodiment, the active electronic component is approximately at the center of the perimeter. The plurality of traces may be disposed upon the substrate to couple with the plurality of sensor elements and the active electronic component.

The methods and devices described below can be used with any of the various methods for measuring capacitance. Examples of methods for measuring capacitance include using relaxation oscillators, current versus voltage phase shift measurements, resistor-capacitor charge timing, capacitive bridge divider, charge transfer, or the like.

The methods and devices described herein can be used with capacitance touch-sensor elements, sliders, buttons, pads, and so on. One type of touch-sensor element is a varying capacitance sensor element. In its basic form, a capacitive sensor element is a pair of adjacent plates between which there is a small edge-to-edge capacitance. When a conductive object (e.g., finger) is placed in proximity to the two plates, a change in capacitance is measured. Capacitive sensor elements may be used in a capacitance sensor array such as a touch-sensor slider. An example of a capacitance sensor array is a set of capacitors where one side of each is grounded, the active capacitor therefore having only one accessible side.

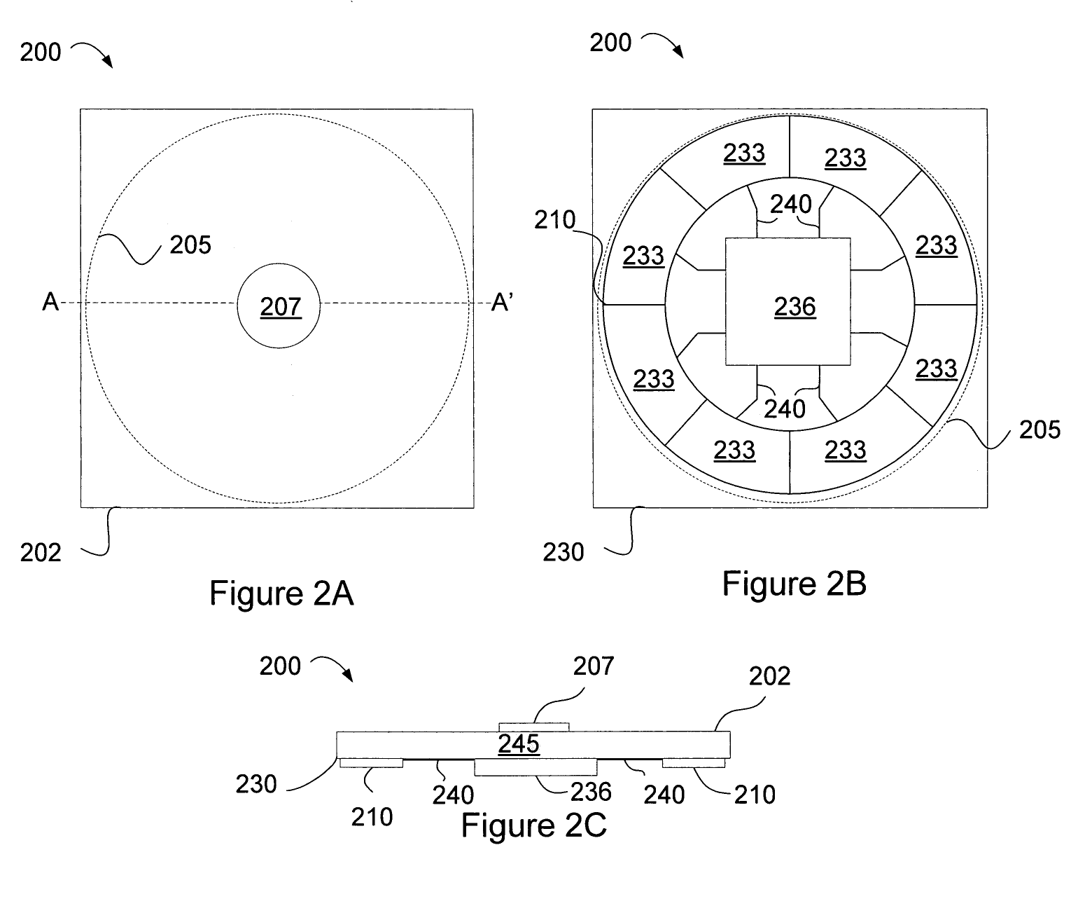

FIGS. 2A-2C illustrate a top view, a bottom view and a cross-sectional side view, respectively, of a touch-sensor device 200, in accordance with one embodiment of the present invention. FIG. 2A shows a top layer 202 of a substrate 245, on which is disposed a touch-sensor button 207. FIG. 2B shows a bottom layer 230 of the substrate 245, on which is disposed a touch-sensor slider 210 having a plurality of sensor elements 233, an active electronic component 236, and multiple traces 240. FIG. 2C shows a cross sectional view of the touch-sensor device 200 taken horizontally across line A-A′.

Referring to FIGS. 2A-2C, the substrate 245 may be flexible or inflexible. The substrate 245 may be a printed circuit board (PCB) made of standard materials, such as FR4 or Kapton™ (e.g., flexible PCB). Substrate 245 thickness may vary depending on multiple variables, including height restrictions and sensitivity requirements. In one embodiment, the substrate 245 has a thickness that is at least approximately 0.3 millimeters (mm). Alternatively, the substrate 245 may have other thicknesses, for example, 0.015 inches or 0.062 inches. It should be noted that thicker substrates 245 may yield better results. The substrate 245 length and width define a substrate 245 area, and are dependent on individual design requirements for the device on which the touch-sensor device 200 is mounted, such as a notebook or mobile handset.

The plurality of sensor elements 233 are disposed non-linearly in a substantially toroidal shape on the bottom layer 230 of the substrate 245. Each of the plurality of sensor elements 233 has a convex curved edge, which represents the outer edge of the toroidal shape of the touch-sensor slider 210, and two substantially straight edges, which represent the boundary of adjacent sensor elements. The convex curved edges of the plurality of sensor element 233, taken together, define a perimeter 205 that is approximately equal to the total sensing area. The perimeter 205 can have an area approximately equal to the surface area (size) of a layer of the substrate 245. Even though the perimeter 205 shown is defined by the convex curved edges of the plurality of sensor elements 233, the perimeter 205 can be defined by other features of sensor elements, such as their centers, inner edges, etc.

In the illustrated embodiment, the perimeter 205 defined by the plurality of sensor elements 233 is in the shape of a circle. In alternative embodiments, the perimeter 205 may have other shapes such as squares, ellipses, etc.

Each of the plurality of sensor elements 233 may be a conductive trace, connected between a conductive line and a ground. When a conductive object comes into contact or into proximity with a sensor element, the capacitance between the conductive lines and ground varies and can be detected. The capacitance variation may be sent as a signal on the conductive line to the active electronic component 236. By detecting the capacitance variation of each of the plurality of sensor elements 233, the position of the changing capacitance can be pinpointed. In other words, it can be determined which of the plurality of sensor elements 233 has detected the presence of the conductive object, and it can also be determined the motion and/or the position of the conductive object over multiple sensor elements.

Each of the plurality of sensor elements 233 may have a metal backing. Use of a metal backing can increase signal level without increasing noise level. The metal backing can be left floating, or can be electrically grounded.

Sensor elements can be spaced apart to reduce or eliminate any fringe capacitance that might occur between adjacent sensor elements during sensing. The spacing between sensor elements can be uniform or it can vary. In one embodiment, each sensor is spaced approximately 0.020 inches apart. In alternative embodiments, a greater or lesser spacing arrangement may be used.

Touch-sensor sliders 210 can be designed to have two or more sensor elements in a variety of shapes and sizes, depending on the application. Larger sensor elements are generally more sensitive, but require additional space. However, sensitivity does not increase significantly as the size of a sensor element is increased beyond the size of the object to be sensed. This can provide application specific upper limits for sensor element size.

For touch-sensor sliders 210, it can be beneficial to size the plurality of sensor elements 233 small enough that the object to be sensed contacts more than one sensor element at a time. In such a case, actuation of one sensor element results in partial actuation of physically adjacent sensor elements. Where the plurality of sensor elements 233 are capacitance sensors, differential capacitance changes between adjacent sensor elements can be used to determine a centroid position of a conductive object for increased resolution. The differential capacitance changes between adjacent sensor elements can be improved by careful selection of sensor element shape. For example, using a saw tooth pattern on the sides of the plurality of sensor elements 233 that are adjacent to other sensor elements can create more overlap between sensor elements, thereby improving the differential change between them.

In applications for touch-sensor sliders 210, it is often necessary to determine finger (or other conductive object) position to more resolution than the native pitch of the individual sensor elements. The contact area of a finger on a touch-sensor slider 210 is often larger than any single sensor element. In one embodiment, in order to calculate an interpolated position using a centroid, the plurality of sensor elements 233 is first scanned to verify that a given sensor element location is valid. The requirement is for some number of adjacent sensor element signals to be above a noise threshold. When the strongest signal is found, this signal and those immediately adjacent are used to compute a centroid.

Touch-sensor sliders 210 can be designed in a variety of shapes. These shapes can be roughly categorized into closed-cycle and open-cycle designs. In closed cycle designs, such as the toroidal design of FIGS. 2A-2C, each sensor element is adjacent to two other sensor elements, which in effect closes the group of sensor elements into a cycle. Examples of closed cycle designs include circles, ovals, squares, rectangles, triangles, etc. Closed-cycle designs may be used to convey absolute positional information of a conductive object, to emulate a scrolling function of the mouse, to modify variables of degree such as brightness and volume, etc.

Open cycle designs for touch-sensor sliders 210 have two ends, wherein each end has a sensor element that is adjacent to only one other sensor element. Examples of open-cycle designs include horizontal or vertical lines, arcs, and so on. Open-cycle designs may be used for control requiring gradual adjustments. Examples include a lighting control (dimmer), volume control, graphic equalizer, and speed control. Open-cycle and closed-cycle touch-sensor sliders can be interchangeable, in that each may be used to perform functions similar to those performed by the other.

The active electronic component 236 may reside on a common carrier substrate such as, for example, an integrated circuit (IC) die substrate, a multi-chip module substrate, or the like. Alternatively, the components of active electronic component 236 may be one or more separate integrated circuits and/or discrete components. In one exemplary embodiment, active electronic component 236 may be a Programmable System on a Chip (PSoC™) processing device, manufactured by Cypress Semiconductor Corporation, San Jose, Calif. Alternatively, active electronic component 236 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. Additionally, the active electronic component may include any combination of general-purpose processing device(s) and special-purpose processing device(s).

The active electronic component 236 may include hardware, firmware, and/or software, or any combination thereof, that is configured to recognize button operations of the touch-sensor button 207, as well as slider operations from the touch-sensor slider 210, on the touch-sensor device 200. The active electronic component 236 can be disposed within the perimeter 205 of the touch-sensor slider 210. Placement of the active electronic component 236 at least partially within the perimeter 205 can reduce the necessary area of the substrate 245. Decreasing the substrate 245 area can free up space for other elements and facilitate the production of smaller devices. In one embodiment, the active electronic component 236 is placed at approximately the center of the perimeter. In alternative embodiments, the active electronic component 236 is placed off center.

The active electronic component 236 may include circuitry for sensing operations on the one or more sensor elements, and for transferring data to/from a connector (not shown), which may be coupled to an additional circuit that is remote from the active electronic component 236. The active electronic component 236 can detect the presence of a conductive object or objects, determine motion or position, recognize gesture events, or the like. In one embodiment, the active electronic component 236 includes a transceiver for transmitting data to a host so that the host may detect the presence of a conductive object, determine a function to execute, recognize motion, or the like.

Traces 240 are used to electrically couple each of the plurality of sensor elements 233 with the active electronic component 236. Traces 240 may also couple one sensor element to another sensor element. The length of each trace 240 is determined by the distance between a pin of the active electronic component 236 and a corresponding member of the plurality of sensor element 233. Long traces 240 can increase power line common-impedance coupling, increase unwanted capacitance, and act as antennas for high frequency electromagnetic signals. Absorption of electromagnetic radiation can produce undesired artifacts in the signal and decrease sensitivity and signal to noise ratio. The length of the trace 240 can be minimized by placing the active electronic component 236 at least partially within the perimeter 205 of the touch-sensor slider 210. In one embodiment, the maximum length of a trace 240 is approximately 1 centimeter. At this length, no substantial electromagnetic interference occurs below approximately 7.5 GHz. Other lengths for the trace 240 may also be used.

The traces 240 may be formed using a conductive ink. Carbon ink is frequently used as a conductive ink for PCB manufacturing, but alternate types of conductive inks or pastes, such as silver ink, may be used as a trace. Alternatively, metal may also be used as a trace. Though copper is frequently used as a metallic conductive trace in PCB manufacturing, alternate types of metals may also be used, such as gold, aluminum, or the like. Metallic conductive traces on a non-conductive substrate are generally covered by a protective insulating layer known as a solder mask layer. This protective layer keeps the metal from oxidizing and corroding over time.

In the illustrated embodiment, a single touch-sensor button 207 is disposed on the top layer 202 of the substrate 245 within the perimeter 205 of the plurality of sensor elements 233. The touch-sensor button 207 is coupled with a pin of the active electronic component 236 through a trace (not shown). The touch-sensor button 207 may have various sizes and shapes. In one embodiment, the touch-sensor button 207 is a circular button with a diameter of approximately 0.50 inches. In alternative embodiments, different shapes and sizes may be used.

The touch-sensor button 207 may provide button operations to be used independently or dependently of the slider operations of closed-cycle or open-cycle sliders. For example, the slider may operate as a scroll wheel, and the button may be used to select a menu item on a display. Multiple touch-sensor buttons 207 may also be used. Each touch-sensor button 207 may provide different button operations. For example, a first button could be configured to cancel device operations, and a second button could be used to confirm device operations.

The touch-sensor device 200 may include a proximate ground plane (not shown), which may be formed, for example, as a sheet or as a grid. The proximate ground plane can decrease interaction between ground and the plurality of sensor elements 233, and prevent accidental detection through traces rather than sensor elements. The proximate ground plane can be on the top layer and/or the bottom layer. Since capacitance varies with inverse proportion to the distance from the proximate ground plane, a clearance between the proximate ground plane and plurality of sensor elements 233 and/or the proximate ground plane and the touch-sensor button 207 can be varied to set specific capacitance values. The proximate ground plane can have a fill of anywhere between 0% and 100%. In one embodiment, the proximate ground plane is on the same layer as the plurality of sensor elements 233 and has a fill of approximately 40%. In an alternative embodiment, the proximate ground plane is on a layer different from the plurality of sensor elements 233 and has a fill between about 60%-80%.

In one embodiment, the proximate ground plane may be implemented using a carbon (or other conductive material) printed ground plane. Alternatively, the ground plane may be implemented using conductive ink. This printed ground plane may be connected to a system ground using a pressure contact. The pressure contact may be, in one embodiment, a spring metal clip making contact between the conductive lower surface of the board and a corresponding conductive area on the upper surface of the board. Alternatively, the pressure contact may be a ground wire attached to the substrate, or other types of pressure contacts known by those of ordinary skill in the art.

In another embodiment, the proximate ground plane may be provided by a sheet of conductive material placed under the board, and attached to the board using either adhesive or a mechanically mechanism for fastening the sheet of conductive material to the board. The proximate ground plane may be connected to electrical ground in a similar manner to those described for the carbon printed ground plane above. In another embodiment, the proximate ground plane may be formed in other manners, for example, as a grid.

In one embodiment, the touch-sensor device 200 includes an adhesive layer (not shown), and an overlay (not shown). The adhesive layer can be placed directly on top of the touch sensor button 207 and the substrate 245 on the top layer 202 and/or directly on top of the plurality of sensor elements 233, traces 240, active electronic component 236, and substrate 245 on the bottom layer, and is used to affix the overlay to the touch-sensor device 200. Typical material used for connecting the overlay to the substrate 245 is non-conductive adhesive such as “3M™ 467” or “3M™ 468,” provided by 3M™. In one exemplary embodiment, the adhesive layer has a thickness of approximately 0.05 mm. Alternatively, other thicknesses may be used.

The overlay may be non-conductive material used to protect the plurality of sensor elements 233, touch-sensor button 207 and active electronic component 236 from environmental elements and to insulate a user's finger (e.g., or other conductive objects) from the circuitry. The overlay can be ABS plastic, polycarbonate, glass, Mylar™, or other materials known to those of ordinary skill in the art. In one exemplary embodiment, the overlay has a thickness of approximately 1.0 mm. In another exemplary embodiment, the overlay thickness has a thickness of approximately 2.0 mm. Alternatively, other thicknesses may be used.

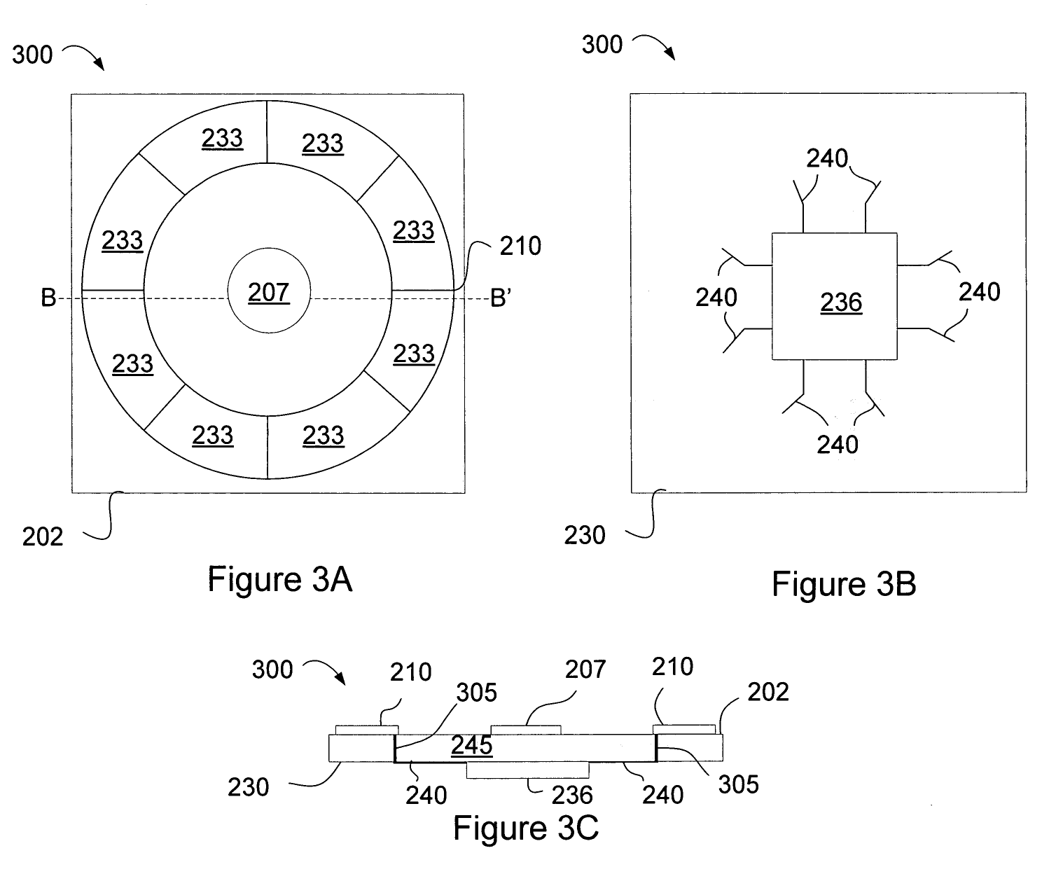

FIGS. 3A-3C illustrate a top view, a bottom view and a cross-sectional side view, respectively, of a touch-sensor device 300, in accordance with one embodiment of the present invention. FIG. 3A shows a top layer 202 of a substrate 245, on which is disposed a touch-sensor button 207 and a touch-sensor slider 210 having a plurality of sensor elements 233. The plurality of sensor elements 233 are disposed in a toroidal-shaped configuration, at approximately the center of which is placed the touch-sensor button 207.

FIG. 3B shows a bottom layer 230 of the substrate 245, on which is disposed an active electronic component 236 and multiple traces 240. Each of the plurality of sensor elements 233 is electrically coupled with a pin of the active electronic component 236 through one of the traces 240. A trace 240 may also connect the touch-sensor button 207 to a pin of the active electronic component 236. FIG. 3C shows a cross sectional view of the touch-sensor device 300 taken horizontally across line B-B′. Vias 305 may be used to connect each of the plurality of sensor elements 233 and touch-sensor button 207 on the top layer 202 with the traces 240 on the bottom layer.

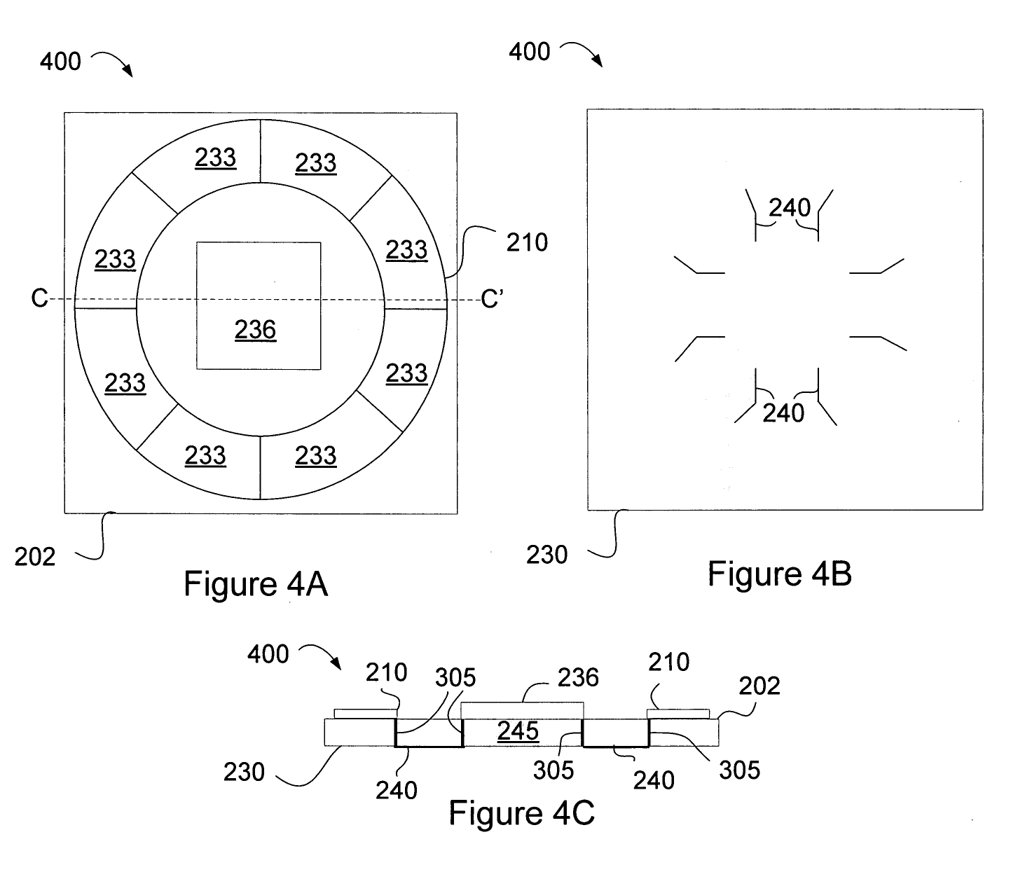

FIGS. 4A-4C illustrate a top view, a bottom view and a cross-sectional side view, respectively, of a touch-sensor device 400, in accordance with one embodiment of the present invention. FIG. 4A shows a top layer 202 of a substrate 245, on which is disposed a touch-sensor slider 210 having a plurality of sensor elements 233. The plurality of sensor elements 233 are disposed in a toroidal-shaped configuration, at approximately the center of which is placed an active electronic component 236.

FIG. 4B shows a bottom layer 230 of the substrate 245, on which is disposed multiple traces 240. Each of the plurality of sensor elements 233 is electrically coupled with a pin of the active electronic component 236 through one of the traces 240. FIG. 4C shows a cross sectional view of the touch-sensor device 400 taken horizontally across line C-C′. Vias 305 may be used to connect the active electronic component 236 and the plurality of sensor elements 233 on the top layer 202 with the traces 240 on the bottom layer.

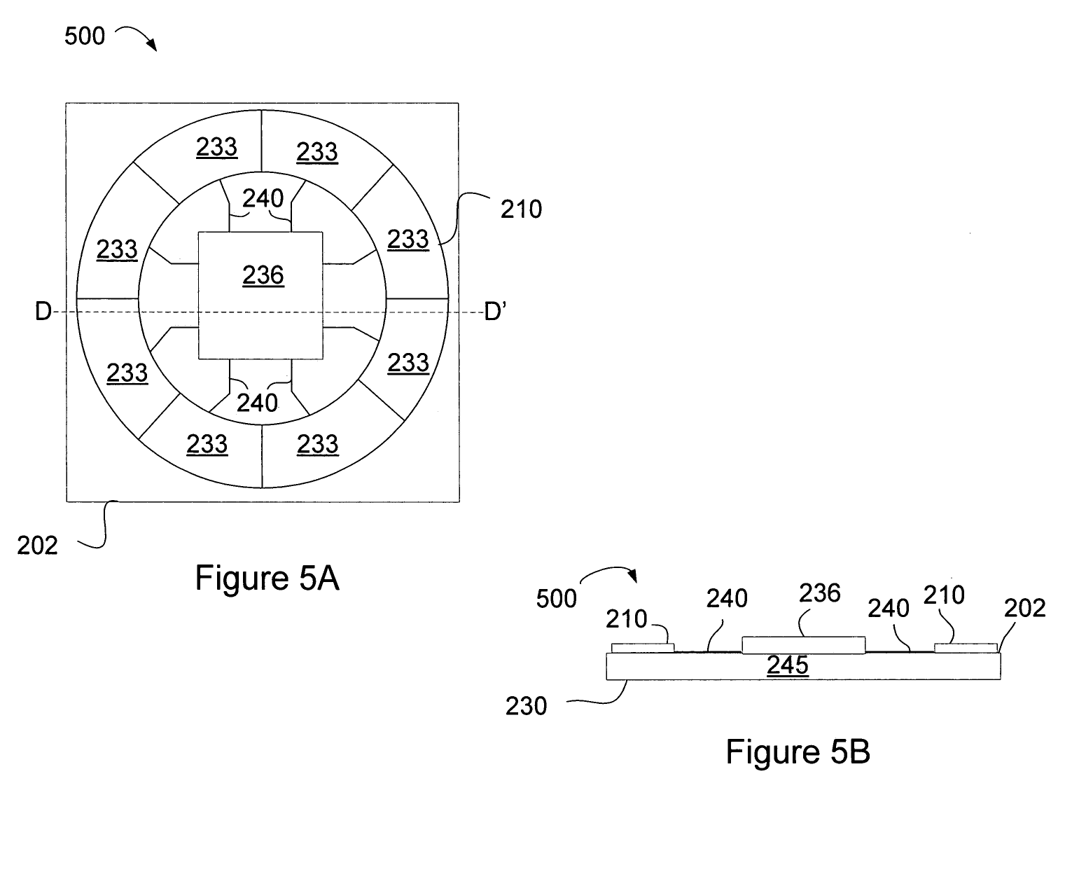

FIGS. 5A-5B illustrate a top view and a cross-sectional side view, respectively, of a touch-sensor device 500, in accordance with one embodiment of the present invention. FIG. 5A shows a top layer 202 of a substrate 245, on which is disposed a touch-sensor slider 210 having a plurality of sensor elements 233. The plurality of sensor elements 233 are disposed in a toroidal-shaped configuration, at approximately the center of which is placed an active electronic component 236. Each of the plurality of sensor elements 233 is electrically coupled with a pin of the active electronic component 236 through traces 240. FIG. 5B shows a cross sectional view of the touch-sensor device 500 taken horizontally across line D-D′.

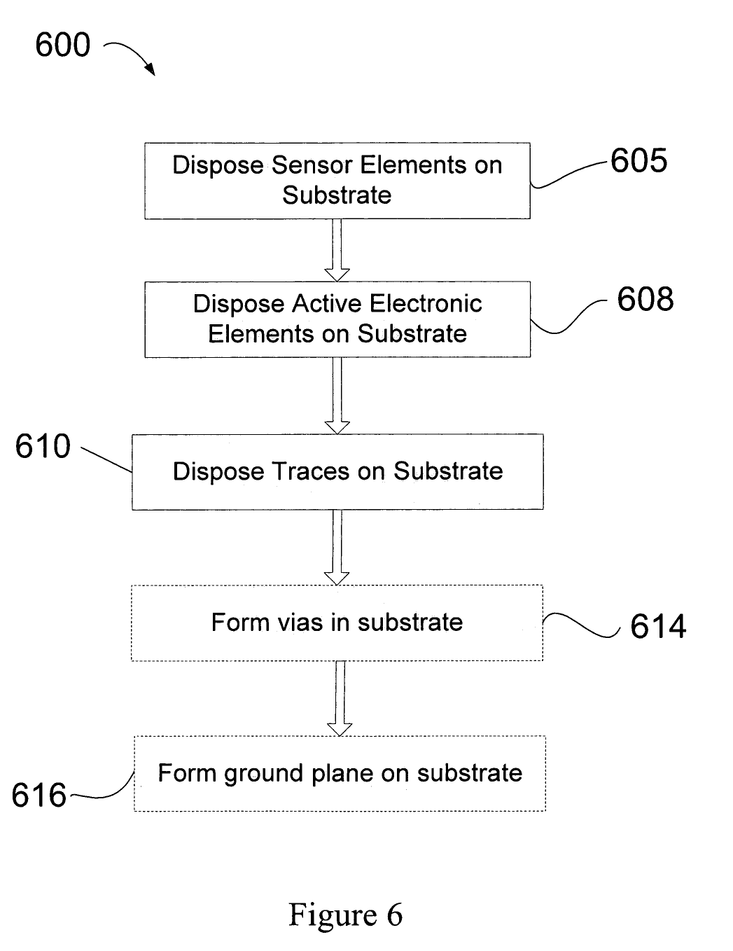

FIG. 6 illustrates a flow diagram 600 of a method for manufacturing a touch-sensor device, in accordance with one embodiment of the present invention. One or more sensor elements are disposed on a substrate (block 605). The sensor elements may be disposed on a top layer and/or a bottom layer of the substrate. The sensor elements may be disposed on the substrate in a linear or a non-linear arrangement. In one embodiment, the sensor elements are disposed contiguously on the substrate to form a circle.

An active electronic component is disposed on the substrate (block 608). The active electronic component may be disposed on the top layer or the bottom layer of the substrate. In one embodiment, the active electronic component is disposed at least partially within a perimeter defined by the sensor elements.

The active electronic component may be disposed on the substrate with the use of pads and lands, to which electronic components can be mounted. Such pads and lands are typically plated, because bare copper is not readily solderable. The active electronic component may be attached to the substrate using a through-hole construction, where the electronic component's leads may be inserted and electrically and mechanically fixed to the board with a molten metal solder. Alternatively, the electronic component may be attached to the substrate using a surface-mount construction. In surface-mount construction, the electronic component is soldered to pads or lands on the surface of the substrate.

At block 610, traces are disposed on the substrate to electrically couple the processing device with the sensor elements. The traces may be disposed on the top and/or bottom layer of the substrate. In one embodiment, disposing the traces on the substrate includes patterning a conductive layer onto the substrate. One method to pattern a conductive layer is to deposit conductive material onto the substrate, such as by sputtering, and etching the deposited material. A solder mask may be patterned onto the traces to insulate them from oxidation and corrosion over time.

At block 614, vias are formed in the substrate. Vias may be used to connect electrical components or traces that are disposed on opposite layers of the substrate. In one embodiment, forming vias includes drilling holes in the substrate and filling the holes with a conductive material.

At block 616, a ground plane is formed on a layer of the substrate. A ground plane can be formed on the same layer as other electrical components and/or traces, or it may be formed on a layer by itself.

The shapes and patterns of the sensor elements described herein may be generated using manufacturing techniques known by those of ordinary skill in the art. For example, lithography and etching may be used. Lithography is the process of transferring patterns of geometric shapes on a mask to a thin layer of radiation-sensitive material (also known as resist), covering the surface of a semiconductor wafer. These patterns define the various regions in an integrated circuit such as the sensor elements of the sensing device. The resist patterns defined by the lithographic process are not permanent elements of the final device but only replicas of circuit features. The pattern transfer is accomplished by an etching process which selectively removes unmasked portions of a layer. The etching process may include either wet chemical etching, plasma etching, or dry etching techniques.

One type of lithography is photolithography (also known as optical lithography). In photolithography the resist is a photoresist layer. Photoresist is a chemical that hardens when exposed to light (often ultraviolet). The photoresist layer is selectively “hardened” by illuminating it in specific places. A transparent plate, also referred to as a photomask, is used in conjunction with a light source to shine light on specific areas of the photoresist. The photomask includes the predetermined pattern printed on it.

Photolithography techniques are known by those of ordinary skill in the art, and accordingly, additional details have not been included so as to not obscure the embodiments of generating the predetermined patterns described herein. In another embodiment, the shapes and patterns described herein may be generated by other manufacturing techniques, such as manufacturing techniques used in film deposition, patterning, and semiconductor doping. For example, the plurality of sensor elements that are non-linearly disposed on the sensing device are generated by impurity doping techniques. The manufacturing techniques described herein may be used to form the shapes and patterns of the sensing device. Moreover, the manufacturing techniques described herein may be used to electrically connect and/or electrically isolate sensor elements and their corresponding conductive lines that couple to the processing device.

Embodiments of the present invention, described herein, include various operations. These operations may be performed by hardware components, software, firmware, or a combination thereof. Any of the signals provided over various buses described herein may be time multiplexed with other signals and provided over one or more common buses. Additionally, the interconnection between circuit components or blocks may be shown as buses or as single traces. Each of the buses may alternatively be one or more single traces and each of the single traces may alternatively be buses.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A touch-sensor device, comprising:
a substrate;
a plurality of sensor elements, non-linearly disposed upon the substrate, that define a perimeter;
an active electronic component disposed upon the substrate and situated at least partially within the perimeter and
a plurality of traces disposed upon the substrate, the traces coupled with sensor elements and the active electronic component.

2. The touch-sensor device of claim 1, wherein:
the substrate has a top layer and a bottom layer;
the plurality of sensor elements and the active electronic component are disposed upon the top layer; and
the plurality of traces are disposed upon the bottom layer.

3. The touch-sensor device of claim 2, further comprising an electrical ground disposed on the bottom layer.

4. The touch-sensor of claim 1, wherein the substrate has a top layer, and wherein the plurality of sensor elements, the active electronic component, and the plurality of traces are disposed upon the top layer.

5. The touch-sensor of claim 4, wherein the substrate has a bottom layer, and wherein an electrical ground is disposed upon the bottom layer.

6. The touch-sensor device of claim 1, further comprising:
a separate sensor element disposed upon the substrate; and
a separate trace coupling the separate sensor element with the active electronic component.

7. The touch-sensor device of claim 6, wherein the separate sensor element is situated within the perimeter.

8. The touch-sensor device of claim 6, wherein the substrate has a top layer and a bottom layer, wherein the separate sensor element is disposed upon the top layer, and wherein the plurality of sensor elements, active electronic component, plurality of traces and separate trace are disposed upon the bottom layer.

9. The touch-sensor device of claim 6, wherein the substrate has a top layer and a bottom layer, wherein the separate sensor element and the plurality of sensor elements are disposed upon the top layer, and wherein the active electronic component, plurality of traces and separate trace are disposed upon the bottom layer.

10. The touch-sensor device of claim 9, further comprising an electrical ground disposed on the bottom layer.

11. The touch-sensor device of claim 1, wherein the substrate has an area approximately the size of a perimeter.

12. The touch-sensor device of claim 1, wherein the active electronic component is situated in approximately a center of the perimeter.

13. The touch-sensor device of claim 1, wherein the perimeter defined by the plurality of sensor elements is approximately a circle.

14. The touch-sensor device of claim 1, wherein each of the plurality of traces has a length not greater than about one centimeter.

15. The touch-sensor device of claim 1, wherein the substrate comprises a non-conductive substrate, the plurality of sensor elements comprises a plurality of metal sensor elements, and the active electronic component comprises a controller.

16. A method of manufacturing a touch-sensor device, comprising:
disposing a plurality of sensor elements non-linearly upon a substrate, wherein the plurality of sensor elements defines a perimeter;
disposing an active electronic component at least partially within the perimeter upon the substrate; and
disposing a plurality of traces upon the substrate to couple the plurality of sensor elements with the active electronic component.

17. The method of claim 16, further comprising disposing an electrical ground upon the substrate.

18. The method of claim 16, further comprising:
disposing a separate sensor element upon the substrate; and
using a separate trace to couple the separate sensor element with the active electronic component.

19. The method of claim 16, wherein the substrate has an area approximately equal to a size of the perimeter.

20. The method of claim 16, further comprising situating the active electronic component at approximately a center of the perimeter.

21. The method of claim 16, wherein the perimeter defined by the plurality of sensor elements is approximately a circle.
